(19) United States
(12) Patent Application Publication
(10) Pub. No.: US 2014/0058880 A1
(43) Pub. Date: Feb. 27, 2014

(54) RETAIL FITTING ROOM/FITTING ROOM ATTENDANT SYSTEM AND METHOD

(71) Applicant: Corey G. Konaxis, Beverly, MA (US)

(72) Inventor: Corey G. Konaxis, Beverly, MA (US)

(21) Appl. No.: 13/916,556

(22) Filed: Jun. 12, 2013

Related U.S. Application Data
(60) Provisional application No. 61/658,701, filed on Jun. 12, 2012.

(51) Int. Cl. G06Q 30/06; G06Q 50/00

(52) U.S. Cl. CPC G06Q 30/0621; G06Q 50/00
USPC 705/26.5

(57) ABSTRACT

A method and system for requesting an item in a fitting room using an electronic device includes detecting an identifier associated with the item; retrieving option data associated with the identified item; detecting a selection of an option from the option data; and transmitting a request to another electronic device for retrieval of the item with the selected option.

### BACKGROUND

1. Field

The aspects of the present disclosure relate generally to interactive electronic systems, and in particular to an electronic fitting room attendant.

2. Description of Related Art

Currently, retail fitting rooms and fitting room attendant (FRA) relationships with customers are out of sync with today's modern technology. Retail employees' responsibilities are to attend fitting rooms while at the same time working the floor, the register, and maintaining the floor “standards” for the company. Associates come in and out of fitting rooms randomly, asking customers if they need help. Some customers, once let into a fitting room, are never attended to again while some maybe over asked for help. Customers have different needs and expectations. Statistics generally indicate that most retail complaints are related to fitting room issues. Now, it is difficult to determine which customer wants more attention versus the customer that wishes to be left alone.

Other issues related to trying on clothing items in a fitting room can include, for example, Time constraints leave customers needing help with less options for redressing to try different sizes, styles and options. Customers can feel uncomfortable to open the door for assistance when they are not fully dressed. Guilt can occur with the lack of consumer knowledge of whether or not it is the sales associate's responsibility to get them another size/color etc. Mothers with young children do not want to leave them unattended in a fitting room. Shoppers do not want to leave their personal items unattended in a fitting room. Customers can get angry when they are being overly helped while in the fitting room.

From a corporate perspective, an unsatisfactory fitting room experience, such as those described above, can lead to lost sales. Other issues can include complaints related to poor service, inconsistent customer service due to lack of knowledge for individual customer needs and miscommunications through associates in determining which customers have been serviced.

Accordingly, it would be desirable to provide a system that resolves at least some of the problems identified above.

### SUMMARY

As described herein, the exemplary embodiments overcome one or more of the above or other disadvantages known in the art.

One aspect of the present disclosure relates to a method for requesting an item in a fitting room using an electronic device. In one embodiment, the method includes detecting an identifier associated with the item; retrieving option data associated with the identified item; detecting a selection of an option from the option data; and transmitting a request to another electronic device for retrieval of the item with the selected option.

Another aspect of the present disclosure relates to product request and retrieval system for a fitting room. In one embodiment, the system includes a controller; an electronic terminal in the fitting room communicatively coupled with the controller; and a mobile terminal communicatively coupled with the controller and the electronic terminal; wherein the electronic terminal is configured to transmit a product identifier to the controller; the controller is configured to process the request and provide the electronic terminal with product options related to the product identifier; the electronic terminal is configured to transmit a request for an updated product including one or more of the product options; and the mobile terminal is configured to receive the request and provide an indication of the electronic device from which the request was transmitted and details of the product options associated with the request.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 illustrates a schematic block diagram of an exemplary system incorporating aspects of the disclosed embodiments.

FIGS. 2-7 illustrates one embodiment of a process incorporating aspects of the present disclosure.

FIGS. 8-12 illustrate another embodiment of a process incorporating aspects of the disclosed embodiments.

### DETAILED DESCRIPTION OF THE DISCLOSED EMBODIMENTS

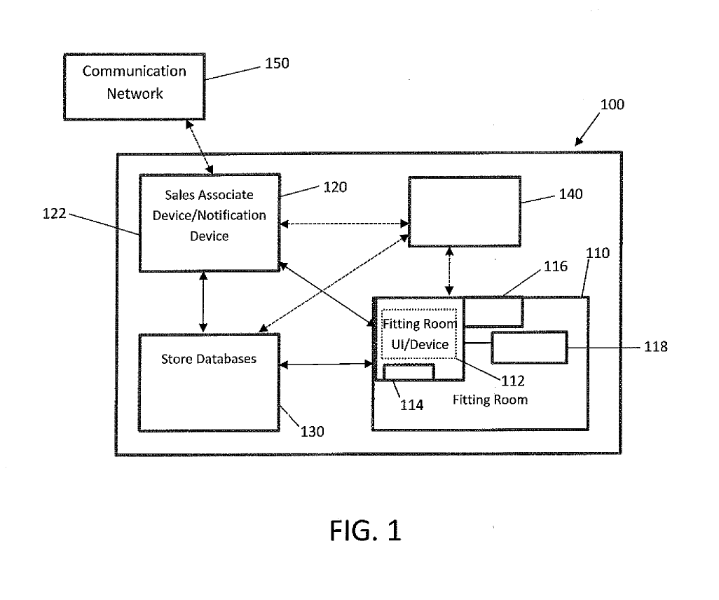

Referring to FIG. 1, one embodiment of a system 100 incorporating aspects of the present disclosure is illustrated. The aspects of the present disclosure are directed to a substantially instant and direct means of electronic communication between a sale associated and a customer that provides for a quick identification of a customer's needs. A non-intrusive mobile communication device provides a fitting room service and interface between the customer and the store, or the store associate. The aspects of the disclosed embodiments will provide an interactive system and interface that will allow a user (generally referred to herein as a “customer”) to identify and select, for example, a clothing article of interest and have the article delivered to, for example, the dressing or fitting room, as those terms are generally understood.

Referring to FIG. 1, in one embodiment, the customer is able to input information related to an item of interest, such as for example, an article of clothing, into a communication or computer device 110, also referred to as an electronic terminal, located in the fitting room 102. The device 110 will generally comprise a computer or other suitable electronic communication device that includes a user or display interface that not only presents information but also allows for the input of data and information. Examples of such devices can include, but are not limited to, a wireless terminal, mobile communication device, a smart telephone, a touch or near touch device, a Mobile Internet Device (MID), a tablet computer, a phablet, an Ultra-Mobile Personal Computer (UMPC), a tablet, a Personal Digital Assistant (PDA), a web pad, a Personal Computer (PC), a Handheld PC, a laptop computer, and a cellular phone. In one embodiment, the device 110 may, for example, be implemented using a smart telephone that includes computing hardware which is operable to execute one or more software or computer program products recorded on machine-readable data storage media.

In one embodiment, the communication device 110 in the fitting room 102 can include a user interface or display 112 that allows the user to input information related to, for example, an article of clothing they are interested in or currently trying on. In one embodiment, the user interface 112 can comprise a graphical user interface, such as a touch screen for example. In one embodiment, the user interface 112 can include a scanner device 114 that is configured to detect or scan a product identification code or such other suitable code or identifier that is used to identify a particular product. In alternate embodiments, the scanner device 114 can be a separate device. For example, many clothing items or garments will include a tag or other label that includes a barcode or other indicia. In this embodiment the scanner device 114 comprises a barcode scanner and the indicia can be scanned to obtain the identifying information. The identifying information can be used to obtain information on or related to the product from a database or other look-up table. In one embodiment, the scanner device 114 can comprise an RFID reader, and the product tag comprises an RFID device.

In an alternative embodiment, the user interface 112 can comprise a mobile communication device of the customer. In this embodiment, the fitting room 102 can provide a connection or connector 116, such as for example a docking station or interface, that will allow the user to couple the mobile communication device 110 in this example to the system 100. Alternatively, the mobile communication device 110 can couple to the system 100 using communication network 150. The communication network 150 will generally comprise a wireless communication technology, such as cellular, WLAN, or Bluetooth, for example. The communication network 150 will generally allow all of the components and devices shown in FIG. 1 to communicate to and between each other.

In one embodiment, though, for example an application on the mobile communication device 110, the mobile communication device 110 can be configured to communicate with and within the system 100 of the disclosed embodiments. In one embodiment, the customer can manually input the product identifier, which can include for example an alphanumeric code, bar code or other suitable indicia, such as by text input, imaging, scanning, or such other suitable method, into the mobile communication device 110 which will transmit input the information into the system 100 as is otherwise described herein.

In one embodiment, once the product is identified, the customer can be presented with choices of alternative options for the same or similar product. The options can be presented on the communication device 110 being used in the fitting room in any suitable manner. The alternative product options can include, but are not limited to, size, color and style, for example. The customer can then select one or more products that they desire to try by activating a selection input on the communication device 110.

Once the alternative product(s) is selected, the selection information is transmitted to, for example, a communication device 120 associated with a sales associate. The communication device 120 can include any suitable mobile communication device. Examples of such devices can include, but are not limited to, a wireless terminal, mobile communication device, a smart telephone, a Mobile Internet Device (MID), a tablet computer, a phablet, an Ultra-Mobile Personal Computer (UMPC), a tablet, a Personal Digital Assistant (PDA), a web pad, a Personal Computer (PC), a Handheld PC, a laptop computer, and a cellular phone. In one embodiment, the device 120 may, for example, be implemented using a smart telephone that includes computing hardware which is operable to execute one or more software or computer program products recorded on machine-readable data storage media. In one embodiment, this can include presenting the selection information on a display of computer device as a request and either automatically or manually assigning an associate to the request.

A controller or other computer device 140 can act as a central controller that facilitates the transmission and processing of the requests, as is generally described herein. The controller 140 can be communicatively coupled with each of the devices shown in FIG. 1, and enable the processing of the product identifier, request and status information, and other aspects of the embodiments disclosed herein. The controller 140 can also facilitate transmitting the selection information to a communication device 120 of a suitable sales associate. In one embodiment, the controller 140 is comprised of machine-readable instructions that are executable by a processing device.

In one embodiment, the system 100 is configured to identify one or more sales associates, select a most available associate, and transmit the information to their mobile device. This presupposes that such information, such as a mobile telephone number or email of a particular associated, are presorted in the store's database 130 or system. The sales associate can then retrieve the requested item and deliver it to the dressing or fitting room 102 of the customer. Alternatively, text messaging, electronic mail or such other suitable communication system can also be used.

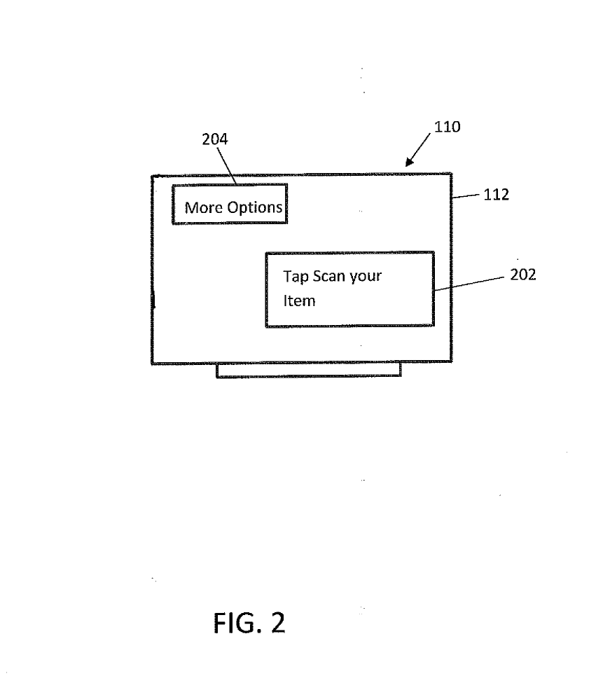

FIGS. 2-7 illustrated one embodiment of an exemplary process incorporating aspects of the present disclosure.

FIG. 2 illustrates an exemplary user interface 112 that can be presented on a display device 110 in a fitting room 102, as shown in FIG. 1. In this example, the user interface 112 provides an input area 202 that allows the user to start the process and scan the identification tag or device associated with the product. In the event the product does not have a scannable identification tag, a “More Options” selection button 204 is provided to allow the user to select another way of inputting the product information or requesting further assistance from a sales associate.

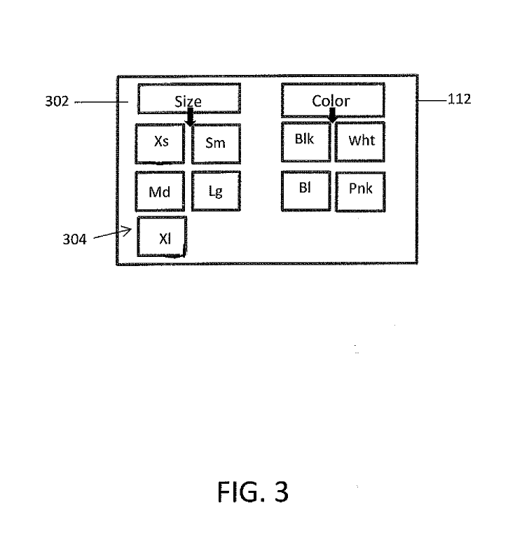

FIG. 3 illustrates an exemplary screen shot of configuration options related to the product identified from the scanning shown in FIG. 2. The exemplary options shown in FIG. 3 include, but are not limited to, size and color options. The user can select via the input screen 302 a size and color of the particular product they would like to try. The selection buttons 304 in this embodiment are soft buttons on a touch screen.

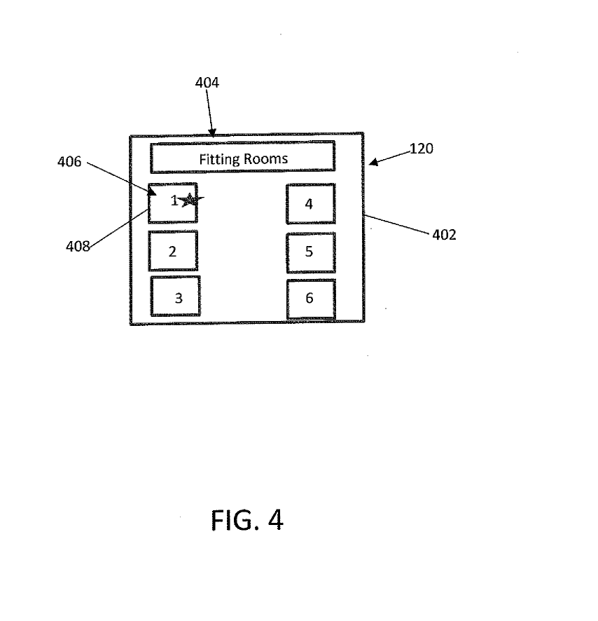

FIG. 4 is an illustration of a display 402 on the device 120 of the sales associate. In this example, the exemplary screen shot 404 illustrates the fitting room layout, and fitting room numbers. An identifier 406, such as a star for example, indicates that assistance is required in Fitting Room 1. The button 408 associated with Fitting Room 1 is selectable, and the sales associate can select the button 408 to receive the details on the assistance that is required.

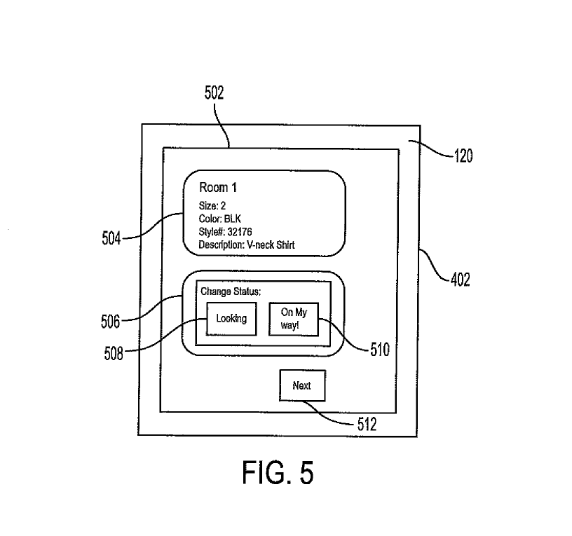

FIG. 5 is a screen shot 502 that can be provided on the display 402 of the sale's associates device 120 illustrating exemplary information that can be displayed responsive to the selection of button 408 shown in FIG. 4. In this example, a first field 504 can be provided to inform the sales associate of the fitting room number, the product type and the particular product configuration, including the size, color and style. A second field 506 can be provided that allows the sales associate to change or address the status of the customer request, including indicating that the sales associate is looking for the product (selectable button 508) or that the sales associate is on the way (selectable button 510). In alternate embodiments, any suitable indication buttons or other selection options can be provided that will allow the sales associate to provide status and other information to the customer requesting assistance. The status information corresponding to the selection of one or more of the selectable buttons 508, 510 can appear on the user interface 112 of the device 110 in the customer's fitting room. In this example, a “Next” selectable button or option can be provided on the display 502 to allow the sales associate to advance to a next screen.

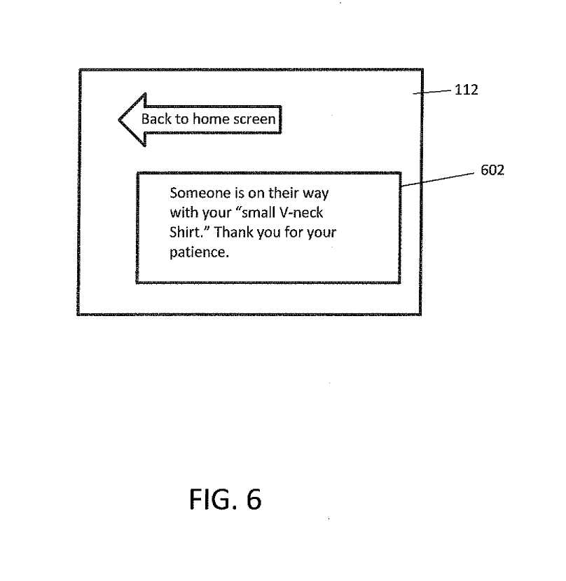

FIG. 6 illustrates a screen shot of the user interface 112 illustrating exemplary information 602 that may appear on the display portion of the user interface 112 shown in FIGS. 1 and 2. In this example, the sales associate has provided status information or a message indicating that the product is on the way, also indicating the particular style and size. In alternate embodiments, any suitable status information or message can be provided.

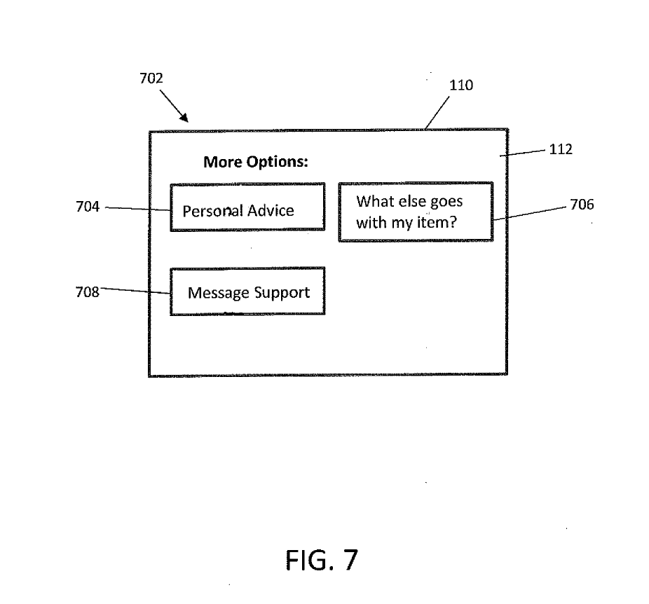

FIG. 7 illustrates an exemplary screen shot 702 of information and data that may be provided on the user interface 112 of the device 110 in a fitting room 102. In this example, the information/request regions 704, 706 and 708 are selectable areas or buttons that allows the customer to request personal advice, more options of products that go with a selected product, or general support, respectively. In alternate embodiments, any suitable number of information or request regions, such as 704, 706 and 708 can be provided in any suitable manner.

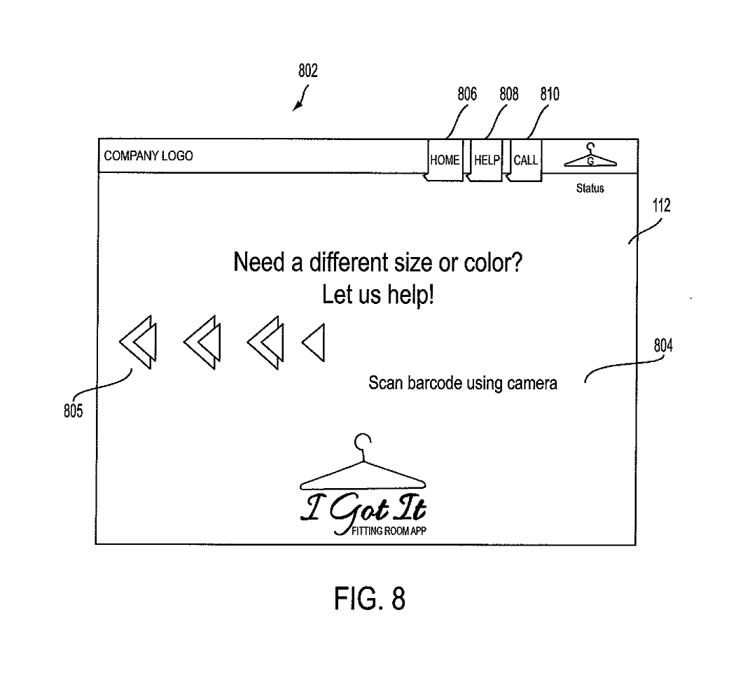

FIGS. 8-12 illustrates additional aspects of the disclosed embodiments. Referring to FIG. 8, an exemplary screenshot 802 that can be provided on the display 112 of the device 110 in the fitting room 102 is illustrated. Although the aspects of the disclosed embodiments are generally described herein with respect to screen shots, in one embodiment, the screen shots represents pages of a website. The aspects of the disclosed embodiments can be practiced via a web enabled interface, where the device 110 is communicatively coupled or connected to a web site or web enabled service providing the selection and processing information and data as is generally described herein.

In the example shown in FIG. 8, an information field 804 on the display 112 informs the customer to scan a barcode from the product identification tag using a camera device, such as camera device 118 illustrated in FIG. 1. An information or data field 805 provides, in this example, arrow indicators to inform the user where the scanning device or other information input device 118 is located. For example, the arrows in field 805 may point to the location of the camera lens or indicia scanner. Alternatively, the camera or scanning device 118 can be a separate device, positioned near or adjacent to the device 110. In alternate embodiments, the product identifier can be inputted in any suitable manner, other than including scanning by a camera. The screen 802 can also include selectable buttons or areas for Home 806, Help 808 and Call 810 functions.

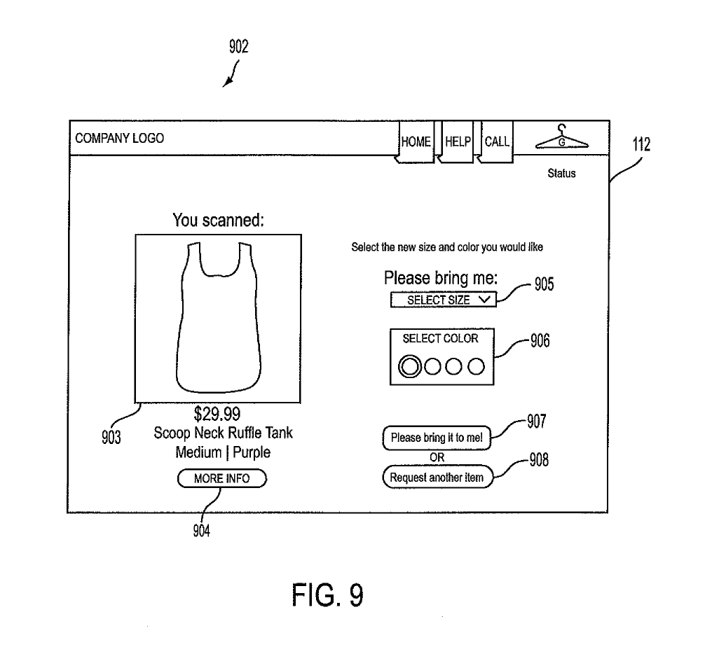

Once the product tag is scanned and the product is recognized by the system 100, such as by identifying the product in the database 130, product information can be presented to the customer. Referring to FIG. 9, an exemplary screen shot 902 that presents product information on the display 112 is illustrated. In this example, a picture of the item is presented in field 903. If more information on the product is desired, the field 904, which is in the form of a selectable button, can be activated in a suitable manner.

In one embodiment, the display 112 can be configured to enable the customer to request a new item. In the example of FIG. 9, the field 905 allows the selection of a different size. Field 906 allows the selection of a different color. In this example, the field 905 is in the form of a drop down menu, that when selected, presents the different sizes that may be available. One of the sizes can then be selected as will be generally understood. In the color selection field 906, the different available color selections are presented in an array of color selections, one of which may be selected. It should be understood that the different options related to or associated with a product can be presented in any suitable information fields and manner that allows ease of viewing and selection. In one embodiment, the field 903 can also be updated to illustrate a particular color or style selected.

In the embodiment shown in FIG. 9, once the different options are selected, selectable fields 907 and 908 allow for a request for the updated product to be submitted, or a new item to be requested.

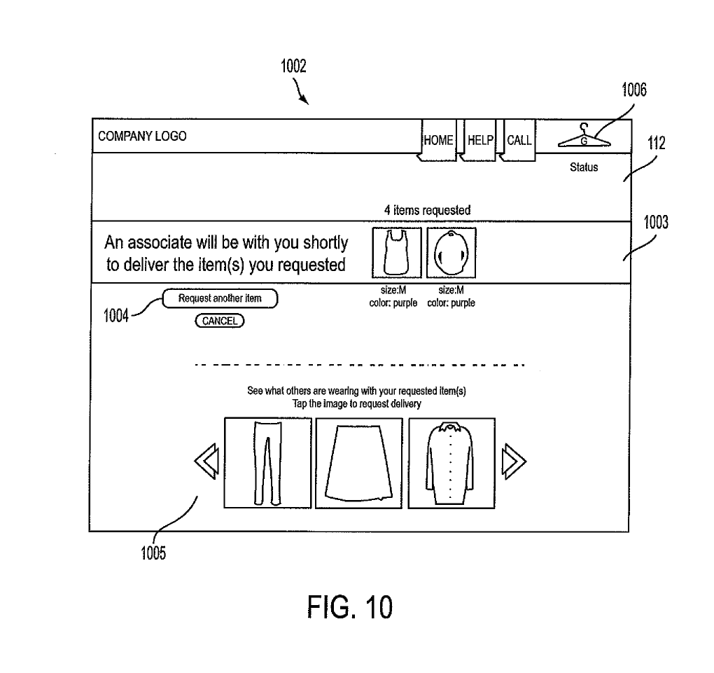

With reference to FIG. 10, a screen shot 1002 that can be presented on the display 112 once a request is submitted, as described with reference to FIG. 9, is illustrated. In this example, pictures of the requested product(s), also referred to as thumbnails, can be presented in the field 1003. Also shown in a message indicating that the requested products are on the way. The field 1004 allows the customer to request another item, the selection of which can return the customer or other user to the home page, such as the page shown in FIG. 8.

Also provided on the page 1002 of FIG. 10 is an information field 1005 that can provide an indication of products, such as articles of clothing or accessories that others are wearing or buying in combination with the product selected by the customer, also referred to as complementary product information. In this example, the computer 140 shown in FIG. 1 is configured to retrieve data stored in the database 130 that correlates the product requested by the customer, from the product identifier, with the other related products. This information and data can be based on prior purchases and selections and stored in the database 130. For example, a field in the database 130 associated with the requested item can indicate that such complementary product information is available. The complementary information can be retrieved and presented. In one embodiment, the field 1005 is a scrollable field that presents scrolling thumbnails of the different complementary products. The displayed items in field 1005 can then be paired with the requested items shown in field 1003.

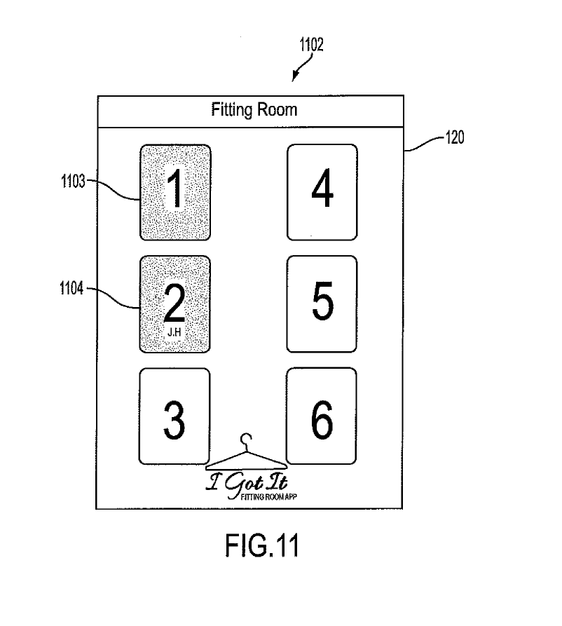

FIG. 11 illustrates a screen shot 1102 of a page as can be presented on the device 120 of a sales associate. In this example, the numbers 1-6 correspond to the different fitting rooms 102 of the facility. It is noted that the numbers 1-6 are merely exemplary, and the system 100 can be tailored to accommodate any suitable number of fitting rooms, including more or less than six. In this example, when a customer initiates a request, such as the request illustrated with respect to FIG. 9, and indicator associated with the particular fitting room is highlighted. In this example, the field 1103 associated with room 1 can be configured to illuminate or blink to draw attention to the room. In alternate embodiments, any suitable indication can be provided that will inform a sales associate of a customer request. This can include visual and aural notifications.

While the above example is described with respect to one sales associate, in one embodiment, the same page 1102 can be presented to each of the sales associates. A request is highlighted as noted above, and any one of the associates can respond to the request by selecting the highlighted indicator 1103 corresponding to the request. In this way, all of the associates can be notified of a request, and an available associate can respond. An identifier corresponding to the responding associate can then be provided with respect to the requesting fitting room, and will be able to be viewed by the other associates on their devices 120. Each of the associates can be provided with the same screen shot view on their device 120 as that shown in FIG. 11. Thus, each associate or other controller, can be apprised of the real time status of the fitting rooms and the requests.

In this example, other fitting rooms that have requests that are being serviced can also be indicated. The field 1104 associated with room 2 has a name of an assigned associate indicated thereon. In alternate embodiments, any suitable indicator can be used to show that a request is being serviced. Empty rooms can also be indicated, such as by color or no color or highlight.

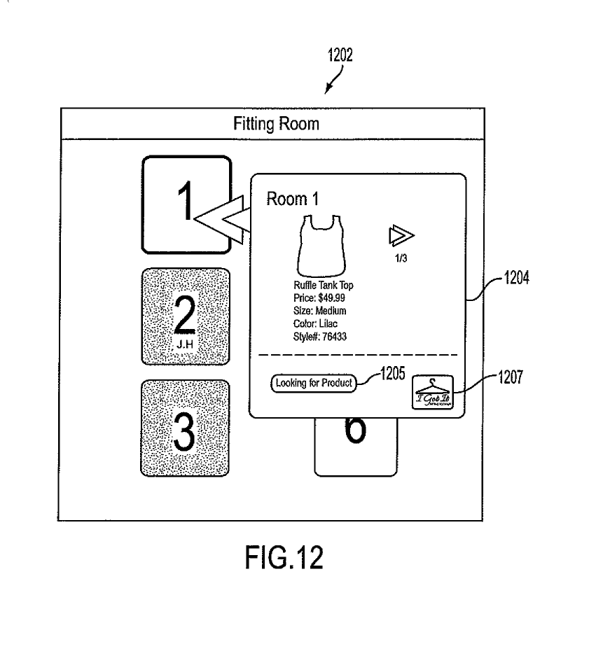

In one embodiment, when a sales associate selects the field 1103 associated with room 1 from where the request has been generated, the requested item will be presented on the associates device 120, such as shown in the screen shot 1202 of FIG. 12. In this example, the field 1204 provide all of the information pertaining to the request, allowing the associate to retrieve the requested item. The associate can update the customer using the “Looking for Item” selection field 1205, the “Done” selection field 1206 or the “I Got It” selection field 1207. In one embodiment, the status of the request can be presented in the status field 1006 on the display 112 for the customer, such as that shown on FIG. 10.

The aspects of the disclosed embodiments provide numerous advantages over the current state of the art. From a customer perspective, a customer will no longer feel uncomfortable in a dressing room due to doors being opened while undressed, will not be discouraged from seeking sales associate assistance. The customer will also be aware that their request is being looked after and there will not be any uncertainty if help is coming. The time and effort needed to redress in order to replace a size or style is reduced. Also, a customer does not have to worry about leaving a child or items unattended in a fitting room or losing a dressing room if you leave to get another item.

From the company perspective the conversion factor of the customer buying what is being tried on will be greater due to all the benefits the aspects of the system of the disclosed embodiments will provide. Also, the sales gained from the effectiveness of the system of the disclosed embodiments should exceed the cost of the program and system. It is anticipated that customer complaints related to fitting rooms and sales associates should decrease and a consistent customer service for the unique characteristics of the consumer. Since each associate can be aware of the status of each fitting room in real time, confusion between sales associates' overlapping or not helping at all in fitting rooms would be substantially reduced, and the sale's associates ability to satisfy the customer can be a high level. A more satisfying, stress free shopping experience created by a system incorporating aspects of the disclosed embodiments will help develop customer loyalty.

The aspects of the disclosed also include suitable processors and processing devices for carrying out the method and process steps described herein. One or more memory devices can be included in the system, such as random access memory and magnetic storage devices. The one or more memory devices can store data, executable instructions or program modules, including software programs and code, for carrying out the processes described herein. The processor(s) or computing hardware can be operable to execute one or more software or computer program products recorded on machine-readable data storage media. In one embodiment, the computer or controller 130 can be configured to execute computer readable instructions stored in a memory device or other data storage for carrying out one or more of the processes described herein.

In one embodiment, the device 110, device 120 and computer 130 can comprise other non-transitory, removable/non-removable, volatile/non-volatile computer storage media. By way of example, the computer 130 can in one embodiment include or comprises a mass storage device that can provide non-volatile storage of computer code, computer readable instructions, data structures, program modules, and other data for the devices 110, 120. For example and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like. In one embodiment, the devices 110, 120 can optionally also include one or more processor as well as memory, as those terms are generally described herein.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit and scope of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for requesting an item in a fitting room using an electronic device, the electronic device being configured to:
detect an identifier associated with the item;
retrieve option data associated with the identified item;
detect a selection of an option from the option data; and
transmit a request to another electronic device for retrieval of the item with the selected option.

2. The method of claim 1, comprising detecting the identifier using a indicia scanner.

3. The method of claim 1, wherein the identifier is a bar code.

4. The method of claim 1, wherein the request is transmitted over the internet to the other electronic device.

5. The method of claim 1, wherein the electronic device is a touch screen device.

6. The method of claim 1, comprising presenting the option data on a display of the electronic device, and enabling each option to be selected.

7. The method of claim 1, comprising transmitting a status from the other electronic device to the electronic device to indicate a status of a processing of the request.

8. The method of claim 1, comprising presenting the request on the other electronic device as a thumbnail image of the item associated with the request together with a listing of the option.

9. The method of claim 1, comprising:
transmitting the detected identifier to a database including product information associated with the item;
retrieving associated product information from the database based on the detected identifier; and
presenting the associated product information in an information field on a display of the electronic device as the option data.

10. The method of claim 9, comprising:
detecting an information field in the database indicating complementary product information associated with the item;
retrieving the complementary product information; and
presenting the complementary product information on the display of the electronic device.

11. A product request and retrieval system for a fitting room, comprising:
a controller;
an electronic terminal in the fitting room communicatively coupled with the controller; and
a mobile terminal communicatively coupled with the controller and the electronic terminal;
wherein the electronic terminal is configured to transmit a product identifier to the controller;
the controller is configured to process the request and provide the electronic terminal with product options related to the product identifier;
the electronic terminal is configured to transmit a request for an updated product including one or more of the product options; and
the mobile terminal is configured to receive the request and provide an indication of the electronic device from which the request was transmitted and details of the product options associated with the request.

12. The system of claim 11, wherein the electronic terminal comprises an indicia scanning device.

13. The system of claim 11, comprising a communication network communicatively coupling the electronic terminal, controller and mobile terminal.

14. The system of claim 11, wherein the electronic terminal comprises a touch screen display device.

15. The system of claim 14, wherein the touch screen display is configured to display a product associated with the request and provide selectable fields on the touch screen display to enable selection of the product options.

16. The system of claim 11, wherein the electronic terminal comprises a mobile communication device and the system includes a coupling interface to couple the mobile communication device to the system.

17. The system of claim 16, wherein the coupling interface is a wireless connection between the mobile communication device and the controller.

18. A computer program product comprising non-transitory computer readable code means, the computer readable code means, when executed in a processing device, being configured to carry out the method recited in claim 1.
